(19) United States
(12) Patent Application Publication
(10) Pub. No.: US 2025/0101950 A1
(43) Pub. Date: Mar. 27, 2025

(54) METHOD FOR MANUFACTURING A CONNECTING DEVICE FOR A TOWER-LIKE STRUCTURE AND TOWER-LIKE STRUCTURE

(71) Applicant: ROSEN 2 Holding AG, Stans (CH)

(72) Inventors: David Moeller, Lingen (DE); Alexander Lindner, Ochtrup (DE)

(21) Appl. No.: 18/575,589

(22) PCT Filed: Jun. 29, 2022
(86) PCT No.: PCT/EP2022/067915

§ 371 Date: Aug. 28, 2024

(30) Foreign Application Priority Data
Jun. 29, 2021 (BE) BE2021/5505

(51) Int. Cl. F03D 13/20; F03D 13/25

(52) U.S. Cl. CPC F03D 13/204; F03D 13/205; F03D 13/25; F05B 2240/95

(57) ABSTRACT

The invention relates to a method for manufacturing a connecting device for a tower-like structure, in particular an offshore wind turbine, wherein the connecting device comprises a plurality of connecting elements, in particular planar connecting elements, which are to be arranged between an upper component of the structure and a lower component of the structure when a slip joint is produced and, for the purpose of load transfer between the upper component and the lower component, are to be positioned next to one another in the peripheral direction about the longitudinal axis and/or in the longitudinal direction thereof with respect to a central longitudinal axis of the structure, wherein data relating to an actual size of the lower component and of the upper component is provided, whereupon the shape, the position and/or the condition of individual or several as well as in particular all connecting elements of the connecting device are least in part determined in a manner specific to the connecting element in order to optimise the load transfer and/or in order to compensate for any deviations of the lower component and/or of the upper component from their desired size, and the connecting elements, that have been manufactured in advance and/or subsequently, are provided for assembly on at least one of the components. The invention also relates to: a tower-like structure, in particular part of an offshore wind turbine; and a wind turbine, in particular an offshore wind turbine.

The present invention relates to a method for manufacturing a connection apparatus for a tower-like structure. The invention further relates to a tower-like structure and a wind turbine comprising such a tower-like structure.

EP 3 443 224 B1 discloses a generic method. However, it has been found that, as a result of deviations of the components which are several meters high and which are typically produced from metal plates, from the desired dimensions thereof, undesirable voltage peaks may occur, in particular at the lower end of the upper component and at the upper end of the lower component.

An object of the present invention is to minimize these voltage peaks.

This object is achieved by a method according to claim 1 and by aspects of subject-matter according to claim 16 or 17. Advantageous embodiments of the invention may be derived from the dependent claims and the following description.

The method according to the invention leads to the production of a connection apparatus for a tower-like structure, in particular an offshore wind turbine, wherein the connection apparatus comprises a plurality of in particular plate-like connection elements which, when a slip joint is produced, are intended to be arranged between an upper component of the structure and a lower component of the structure and which, for the purpose of the load transfer between the upper component and the lower component are intended to be positioned beside each other in a circumferential direction about the longitudinal axis and/or in the longitudinal direction thereof with respect to a longitudinal center axis of the structure. The method is characterized in that data relating to an actual size of the lower component and the upper component are provided, whereupon at least partially the shape, the position and/or the nature of individual or a plurality and in particular all of the connection elements of the connection apparatus are determined in a manner specific to the connection element in order to optimize the load transfer and/or to compensate for any deviations of the lower component and/or the upper component from the desired size thereof (of the lower component and/or the upper component) and the connection elements which have already been produced beforehand or which are produced then are provided for assembly on at least one of the components.

If the connection elements have already been produced in advance and in particular stored in different configurations, they are assembled or provided with reference to the provisions specific to the connection element. Alternatively or additionally, the connection elements are specifically produced according to the provisions and accordingly assembled or provided. Consequently, the provision involves an in particular at least partial, preferably fully automated assembly and making the connection elements available for the purposes of transport to the installation location and the assembly at that location on at least one of the components. For the assembly itself, the respective connection elements may in addition be further processed and prepared as described below.

The connection-element-specific determination in particular of the shape and the position of the plate-like connection elements in an assembly of connection elements is preferably further carried out with the objective of achieving an optimum abutment of the plate-like connection elements, both on the lower and on the upper component. As a result of the deviations of the components or one of the components from the respective desired size, for example, an enlarged gap at one side can be compensated for by a thicker connection element so that also at that location in the event of loading, an optimum force path or load transfer can be produced. In the configuration of the connection elements, the deviations of the components from the desired sizes thereof do not necessarily have to be compensated for. As long as the load transfer between the components is optimized, the arrangement of the connection elements, for example, on a slightly oval component, does not necessarily have to lead to an abutment face which is now no longer oval being produced for the other component. An optimization of the load transfer is present when the loads which are intended to be transferred from one component to the other component are transmitted in the desired manner, for example, therefore, are transferred in particular in a state distributed in a uniform manner over the largest possible surface-areas not in a localized manner or over a small area.

Particularly when at least a portion of the shape of a connection element is determined, the thickness thereof is determined, wherein a series of connection elements which have already been predetermined in terms of length and width can be used. The connection elements are plate-like particularly when the thickness thereof is substantially smaller than the length or width thereof so that plates which extend in a planar manner are, however, produced with a degree of bendability. In particular the thickness is smaller than the length and/or width by at least a factor of 2 or 3.

The actual size of the lower and upper components is in particular determined by at least two points preferably at a height, more preferably by four points at a height, and at the top and bottom and the position thereof with respect to each other. Between the individual points, a shape is then approximately assumed, in particular interpolated in front of the background, for example, a conical shape. In particularly preferred manner, a large number of at least more than 10 measurement points are used by means of which an outer side of the lower component and an inner side of the upper component which is placed over the lower component in order to produce the slip joint is determined. For example, by means of a laser scanning measurement method, more than 100 measurement points are recorded. The actual sizes consequently describe at least approximately the actual outer side of the lower component and the actual inner side of the upper component. Preferably, the respective geometries are described by a large number of points, by means of free-form faces, by means of 2D and/or 3D models so that the connection apparatus can be formed in the most precise manner possible. The actual sizes of the individual components are the real dimensions thereof which, as a result of any tolerances in the production, may differ from the desired dimensions, that is to say, the desired dimensions of the respective components. In particular, the data to be used describe the actual sizes of the lower and/or the upper component with regard to its conicity, ovality and/or also with regard to the offset of individual metal plates, from which the respective components are produced relative to each other. Weld seam elevations, dents or the like may also be described by the data and compensated for at least within the scope of the respective tolerances of the connection apparatus. The nature of the connection elements comprises in particular the Shore hardness, the viscoelasticity, the compressibility, the surface nature thereof and/or any layer construction.

The shape of the connection elements comprises the length, the width and/or the thickness of the, in particular in this instance, plate-like connection elements. Alternatively or additionally, the shape comprises recesses and/or chamfered portions of a respective connection element and/or a thickness progression over the connection element. At least one of these variables is determined in a manner specific to the connection element such that the load transfer between the two components is optimized.

The position of the connection elements comprises in particular the spacing of the connection elements from each other in order to take into account any viscoelastic deformations of the connection elements and also the positioning of respective connection elements on the lower or upper component.

For example, a monopile and a so-called transition piece or a tripod or tetrapod, via the respective supports of which a respective transition piece is installed, may be used as lower and upper components. An upper and lower component may also be a transition piece and a tower or the uppermost portion of a wind turbine having a pod and any wind direction tracking apparatus.

As a result of the compensation for any deviations of the lower and upper components from the desired size or the desired dimensions thereof by means of the connection apparatus according to the invention, an actually desired force path is produced in different loading situations of the tower-like structure.

Advantageously, for the determination of the respective connection elements, the shape of a gap which is provided in the installed state of the components is determined between the upper and lower component on the basis of the actual sizes of the two components. Based on a desired optimized configuration, which may also where applicable be dependent on the material of the connection elements used, of an optimized spacing of the components from each other, the thicknesses of the respective connection elements can then be selected. In this instance-where applicable depending on the material used for the connection apparatus-an optimum mean thickness for the gap which is intended to be at least partially closed by means of the connection apparatus between the upper and lower component can be predetermined (for example, 3, 4 or 5 cm, whereupon the thicknesses of the respective connection elements are determined in accordance with the actual sizes.

For the determination of the thickness of respective connection elements, it is advantageous for them to be selected from a predetermined grid dimension, which is in particular between 10 mm and 120 mm. Corresponding connection elements can thereby be produced in store so that, when the dimensions of the connection elements are determined, they can be selected from a respective plate or connection element size. The distribution of the thicknesses present in determining the size and/or shape of the connection elements is in this instance such that the most complete possible abutment against all the connection elements is produced in the loaded state, that is to say, both at the lower component and the upper component the mutually facing faces of the component and the connection element are in abutment with each other. Of course, the abutment faces of the connection elements are the ones which represent the largest surfaces of the planar or plate-like connection elements. For example, with a 10 mm grid dimension with regard to the connection element thickness, ten different thicknesses between 10 mm and 120 mm inclusive may be kept, wherein the connection elements with respect to this thickness or height have an extent of, for example, 400 mm×800 mm.

The connection-element-specific determination is preferably carried out by means of a EDP apparatus, in which the actual dimensions of the components are stored and in which, based on the deviations from a desired dimension, the respective connection elements are determined. For example, with a slightly oval cross sectional shape of a lower component and a (horizontally) circular upper component in cross section a connection element which is intended to be arranged in each case in the region of the main axis of the ellipse is intended to be constructed to be slightly thinner than a connection element which is arranged in the region of the minor axis. In this instance, for example, an envelope around the connection elements which are arranged on a lower component may be circular again when viewed in cross section. Instead, however, it is necessary that, regardless of whether this is a circular envelope, the loads which are present be correctly transferred via the corresponding connection elements. In this instance, the viscoelastic deformation and/or also compressibility of the connection elements can be taken into account, in the same manner as any specific loads which are present, for example, as a result of an installation location of the components, for example, as a result of a main wind direction.

The EDP apparatus (electronic data-processing apparatus) may be a locally operating system or also an EDP apparatus which is arranged at least partially remote from the operator. The EDP apparatus comprises conventional input, output, communication and storage means and associated data-processing possibilities. For example, it is an EDP device which is capable of locally receiving the data and displaying the information items and which transmits the data for the purposes of calculation of the connection elements to a cloud-based EDP unit. After the determination of the connection elements carried out at that location, the accompanying data can then be transmitted again to the locally operating processor.

As a result of the EDP apparatus, in particular an installation plan, which prescribes the most rapid installation possible of all the connection elements in a preferably predetermined sequence can be produced. This is carried out in particular taking into account an advantageous position of a component which is at least gradually intended to be rotated during the installation. Preferably, the upper component is located for this purpose on a roller system. In the event of an upper component being equipped with connection elements at the inner side, for example, the thicker connection elements may initially be placed on the inner side, whereupon thinner elements then follow. In the case of a rotation which is carried out, for example, through 90° about a longitudinal axis of the component, the region which is located beside it in the circumferential direction can then be coated so that overall, after being rotated three times in a circumferential direction, the inner side of the lower component is completely occupied, wherein a complete occupation means the occupation of all the connection elements which are provided for this purpose and which can also be arranged with spacing with respect to each other.

Preferably, the determination of the connection elements is carried out taking into account an assumed loading thereof, and in particular as a result of a load transfer between a lower component and an upper component. Preferably, it is a load transfer from the upper to the lower component, wherein loads can be determined as a result, for example, of the weight of the upper component including any component of a wind turbine which is intended to be positioned thereon and/or wind load. Alternatively or additionally, these may also be wave-induced loads, for example, as a result of movements of a floating platform, on which a wind turbine is installed. In particular for the components and the connection elements which are arranged therebetween, respective 2D and/or 3D models are used, for example, by means of an FEM simulation.

The determination of the connection elements which is intended to be carried out by means of the EDP apparatus is an optimization problem which particularly as a result of KI-based methods using neural networks enables the determination of the connection elements and in particular the thicknesses thereof. Any training data sets can be obtained by means of simulations based on FEM calculations.

In the calculation of the connection elements, portions of the sizes which are intended to be determined can also predetermined, for example, the connection element material in the form of the provided compressibility, viscoelasticity and/or also, for example, an average size. In the loading calculation, in addition to a main wind direction a dynamic installation operation of the upper component on the lower component may also be taken into account, for example, when initially a first load in the form of the upper component is placed on the lower component and subsequently a pod which contains the rotor and the associated gear arrangement is additionally placed on the upper component.

The data used for determining the connection-element-specific indications may, on the one hand, be individual measurement locations or also models of the actual size. They may also be depictions thereof, for example, in the form of the desired size of the lower and the upper component in addition to any deviations from the respective desired sizes. Accordingly, for example, the calculations in the form of optimization calculations can be carried out based on deviations from the desired size.

In the same manner, in the connection-element-specific determination, tolerances of the components and/or the connection elements, for example, as a result of a measurement can be taken into account so that the resultant uncertainty in the determination, for example, as a result of particularly compressible material, can be taken into account.

In particular, the data of the upper and/or lower component include at least the height in the connection region, the conicity, the ovality, the surface curvature and/or at least one weld seam elevation, wherein the corresponding values may be absolute values or, for example, as with regard to the desired dimensions and the deviations thereof, may also be depictions of the same data. It is thus possible with comparatively few data to carry out the determination of the connection elements. The connection region is the region of the structure which is between (and including) the uppermost edge of the uppermost connection element(s) and the lowest edge of the lowest connection element(s). A weld seam elevation is the height and/or contour of a weld seam in comparison with the surrounding region, which does not constitute a weld seam, of the component at the side of the component facing the connection element during operation of the component.

Advantageously, the connection elements which are intended to be used for the structure are in particular colored and/or characterized by an information carrier, which accordingly simplifies the installation. In this instance, for example, it may be an information carrier which is based on wireless technology, such as an RFID chip, which is automatically provided with corresponding positioning markings so that the procedure of picking the connection elements from a store can be carried out as far as possible in a fully automated manner. Alternatively or additionally, it may also involve stickers or markings on the respective connection element.

In particular with a connection element which is provided with varying thickness, via such an information carrier a relative position of the connection element, that is to say, an orientation with respect to the edges (top, bottom, left, right) with respect to the respective component can be determined so that a rotated and/or mirror-inverted arrangement of the connection element can be excluded.

According to a further development of the method according to the invention, at least one connection element is prefabricated and is adapted by means of the connection-element-specific determination. In this instance, for example, this may involve a shortening of the dimensions, a cutting-out of individual regions, the introduction of hollow spaces for the purpose of changing a compressibility, the backfilling of the hollow spaces, the folding and the preparation of surfaces, coating with adhesive, adhesive film or other coatings, for example, in order to reduce friction. As a result of the storage of individual sizes, the components required can be produced rapidly.

In particular, the connection elements are secured to a lower component or an upper component, wherein preferably at least one of respective surfaces which are intended to be brought into connection with each other are pre-treated, in particular cleaned, surface-activated and/or coated with a bonding agent and/or an adhesive. A surface activation may preferably be carried out in a mechanical, chemical or electrochemical manner, for example, by means of a plasma treatment. The application of bonding agents, adhesives or other coatings is carried out in the same manner as the treatment of the surface of a connection element, in each case at least on a portion of the surface of a respective connection element, wherein, for example, an application apparatus, by means of which a precise processing/equipping of the surface is enabled, is used.

The installation is carried out in particular with reference to the installation plan, which illustrates the position and where applicable also the sequence of individual connection elements which are intended to be arranged with each other or beside each other.

The connection elements may also be secured to each other in order, by combining connection elements of different thicknesses, to be able to provide additional connection elements, the thickness of which is produced as a result of the combination of the thicknesses.

Manually or by means of an application apparatus, the surface of one of the components and/or one of the connection elements may be coated, in particular in a friction-reducing manner, for example, with a PTFE (polytetrafluorethylene). An application apparatus may be a mobile apparatus which is constructed for the installation and which, for example, has a supply region and a discharge region between which a connection element is moved along an application roller. The application apparatus serves to apply, for example, an adhesive, directly before the connection element is secured to the component.

Preferably, the component on which the at least one connection element is arranged is located on the outer covering face thereof, wherein it is in particular arranged on a roller system. The component which is otherwise intended to be arranged vertically with the longitudinal axis thereof with respect to the horizontal underlying surface is thus tilted so that the longitudinal axis thereof extends, for example, though not precisely parallel but instead, not taking into account the conicity, substantially parallel with the underlying surface. For an installation of the connection elements in a peripheral direction about the longitudinal axis, the component which is in particular the transition piece can then be successively rotated, for example, by means of the roller system. The installation over the entire height of the component is consequently simplified.

Furthermore, there may be provided a pressing apparatus which presses a respective connection element or the connection elements with a predefined force on the respective component. In a simple case, it may in this instance be magnets by means of which the connection elements are retained on a surface of the typically metal component. However, it may also be an apparatus which can be adjusted in accordance with the size of the connection elements and which can itself be retained magnetically on the components and which by means of corresponding arms or other pressure elements produces a pressing force on the connection element.

Preferably, the size of the connection elements is configured in such a manner that one of these can be carried by an installation person alone and held on the component during the installation. In this instance, the weight of a connection element is below 50 kg.

Preferably, the data relating to the actual size of the components are obtained by means of an in particular light-based and preferably laser-based measurement apparatus and/or by means of an image analysis on the basis of images produced by the components. In particular, the latter simplifies the recording of the actual sizes. The recorded data can be provided online by the component manufacturers and read into the EDP apparatus.

In order to simplify the method according to the invention, the connection elements are cast in rectangular molds, wherein the material used can provide a degree of resilience so that the plate-like connection elements can be adapted to a curvature of the surface of the respective component. The use of rectangular molds enables in particular the use of open molds and consequently a simpler production. Alternatively, closed molds which may also have curved walls can also be used. After the casting and a conventional first hardening of the connection elements, they are preferably additionally tempered and/or subsequently cleaned, the cleaning being carried out, for example, by means of an isopropanol. This simplifies the subsequent application of bonding agents, adhesives or other coatings. The connection elements may be coated and/or surface-treated before or after a transport to the installation location.

The object set out in the introduction is also achieved with a tower-like structure, in particular a component of an offshore wind turbine, which comprises a connection apparatus which is produced in accordance with one of the preceding claims. It benefits from the advantages of the above-described connection apparatus.

The object is also achieved by a wind turbine, in particular an offshore wind turbine, which has a tower-like structure described above.

Other advantages and details of the invention can be derived from the following description of the Figures. In the schematic drawings:

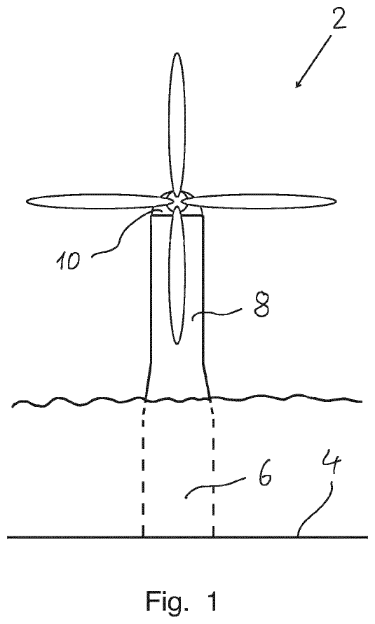

FIG. 1 shows an object according to the invention,

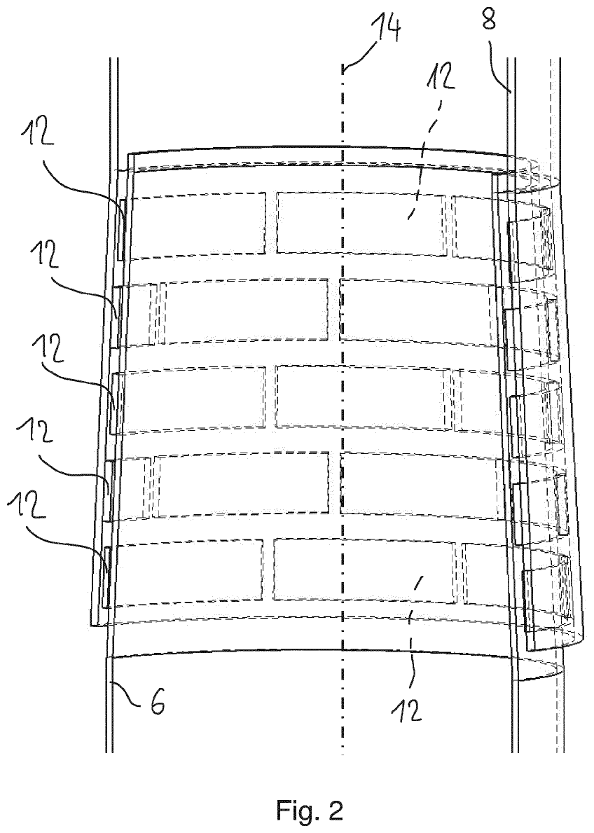

FIG. 2 shows a portion of the object according to the invention according to FIG. 1 as a sectioned and perspective view,

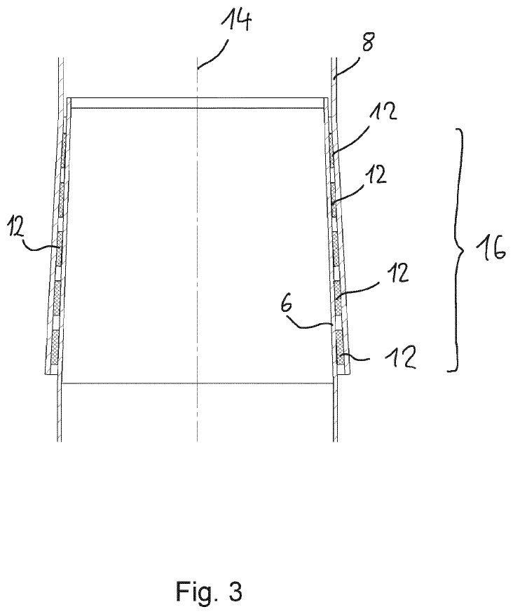

FIG. 3 shows another object according to the invention as a sectioned view,

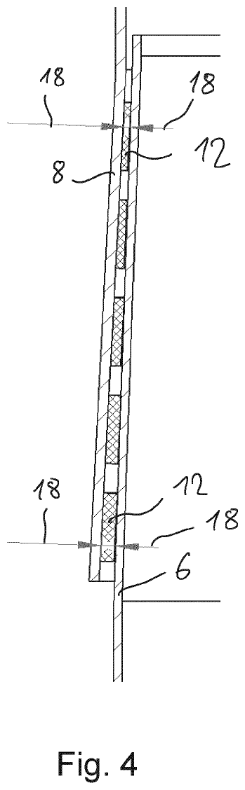

FIG. 4 shows a cut-out of the object according to FIG. 3,

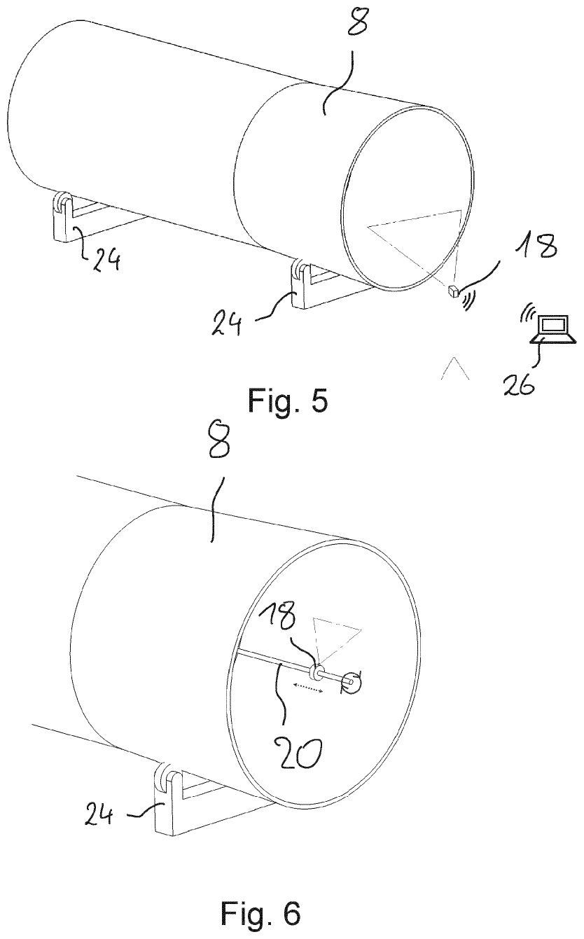

FIG. 5 and

FIG. 6 show views of different measurement operations,

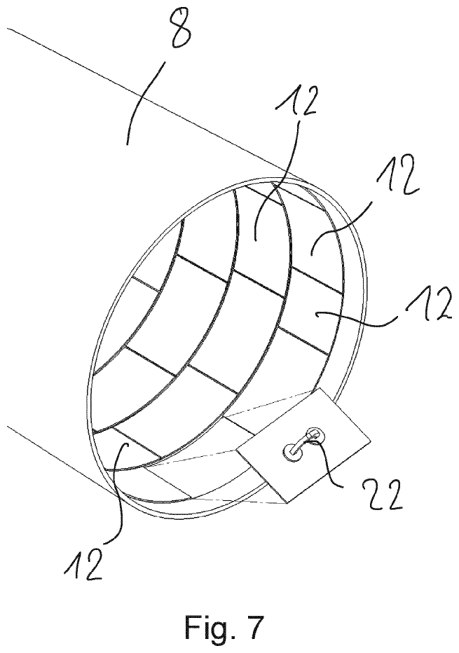

FIG. 7 shows a portion of a production method of an object according to the invention.

Individual technical features of the exemplary embodiments described below may also in combination with the features of the independent claim leads to further developments according to the invention. As long as it is advantageous, functionally identical components are given identical reference numerals.

A wind turbine 2 according to the invention comprises a lower component 6 which is installed vertically on a horizontally extending underlying surface 4 and on which an upper component 8 which has at the upper end thereof a pod 10 having rotors (FIG. 1) is placed. The wind turbine 2 and the tower-like structure which comprises a connection apparatus which cannot yet be seen and the lower component and the upper component 6 or 8 have a longitudinal center axis 14 about which the connection elements 12 are arranged. The longitudinal axis 14 (cf. FIG. 2) extends perpendicularly to the underlying surface 4.

In the exemplary embodiment according to FIG. 1 or 2, the wind turbine 2 or the tower-like structure comprises five rings of in each case a plurality of connection elements 12 which for the purpose of load transfer are arranged between an upper outer surface of the lower component 6 and a lower inner surface of the component 8 and which compensate for the production-related tolerances of these components with respect to the load transfer.

For the determination of the thicknesses of the connection elements 12, after the production of the lower and upper component 6, 8, the actual sizes thereof at least in the respective conically constructed portion thereof were determined, whereupon in an EDP apparatus, after providing the measurement data, the optimum size for the connection elements including the positioning thereof was determined. In the present case according to FIG. 2, this results in the thickness of the connection elements 12 of the rings which are arranged one above the other being constructed differently. In such an optimization calculation, it can additionally be taken as a basis that a primary load transfer in the center of the connection region, that is to say, remote from the upper edge and the lower edge of the conical portion of the lower component 6 and the upper component 8, is constructed to be thicker in order to transmit more loads at that location.

In the exemplary embodiment according to FIG. 3, which shows another exemplary embodiment of a tower-like structure according to the invention, the angle of the cone of the upper component 8 deviates as a result of tolerances in an undesirable manner from the angle of the cone of the lower component 6 so that between them in the illustrated operating position a gap which becomes larger downward in the direction toward the underlying surface is formed. Accordingly, a larger thickness of the connection elements 12 is also produced at the lower end of the connection region 16 which is generally limited in an upward direction by an upper edge of the uppermost connection element(s) 12 and which is generally limited in a downward direction by the lower edge of the lowest connection elements 12. As a result of the compensation of the tolerances, as a result of the connection apparatus according to the invention the desired load transfer is produced between the upper component and the lower component.

In the detailed view according to FIG. 4, it can be seen that the thickness of the lower connection elements 12 is approximately twice as large as the thickness of the upper connection elements 12. The thickness is the spacing of the arrow tips of respective arrows 18 which are perpendicular on the surfaces which are located relative to the lower component 6 or upper component 8. In this instance, the thickness is the thickness of the connection elements in the loaded state thereof. Of course, the thickness in the non-loaded case, in which the connection elements 12 are not deformed, may be larger. In this regard, preferably and generally for the determination of the connection elements, for example, by means of an optimization calculation, loaded connection elements 12 are taken as a basis, but for the production and/or provision the thicknesses of unloaded components are advantageously set out.

In order to determine the actual dimensions of the components 6, 8, mobile measurement apparatuses 18 according to FIG. 5 or 6 can be used. To this end, a laser measurement apparatus 18 can from a region outside the upper component 8 in this instance scan the inner surface thereof in the cone. Alternatively, a measurement apparatus 18 can be introduced into the upper component 8, wherein the measurement apparatus is guided in such a manner on a rod 20 that, as a result of the longitudinal and pivoting movement thereof, the inner side of the upper component 8 is also scanned in the region of the cone thereof. The data recorded by the measurement apparatus 18 are, for example, wirelessly and via the internet transferred into an EDP apparatus 26 in which the thicknesses of the respective connection elements and the position thereof are then determined. As long as different materials are available to produce the connection elements 12, the EDP apparatus 26 in the context of optimizing the load transfer between the upper component 8 and the lower component 6 can also predetermine the material of the connection elements 12. After the production thereof, preferably in a polyurethane casting method, the connection elements 12 are cleaned, surface-treated and coated and subsequently moved with a carrier apparatus 22 to the position provided for this purpose in the component 8, where they are adhesively bonded. The installation of the connection elements 12 is preferably carried out in a lower region of the inner side so that the component 8 for the installation of all the connection elements must be rotated by means of a roller system 24 in a circumferential direction about the longitudinal axis 14, which is perpendicular with respect to the underlying surface during operation, of the component. After the installation of the connection apparatus, the upper component 8 which is in this instance in the form of a transition device can be moved to its place of use and installed at that location.

1. A method for manufacturing a connection apparatus for a tower-like structure, the connection apparatus including a plurality of connection elements which, when a slip joint is produced, are arranged between an upper component of the tower-like structure and a lower component of the tower-like structure, and which for the purpose of the load transfer between the upper component and the lower component are positioned beside each other in a circumferential direction about a longitudinal axis and/or in a longitudinal direction thereof with respect to a longitudinal center axis of the structure, the method comprising the steps of:
providing data relating to an actual size of the lower component and the upper component,
determining at least partially a shape, a position and/or a nature of individual or a plurality of the connection elements of the connection apparatus in a manner specific to the connection element in order to optimize the load transfer and/or to compensate for any deviations of the lower component and/or the upper component from a desired size thereof; and
providing connection elements which have already been produced beforehand and/or are subsequently produced for assembly on at least one of the components.

2. The method as claimed in claim 1, wherein for the determination of the respective connection elements, the shape of a gap which is provided in the installed state of the components is determined between the upper component and lower component on the basis of the actual sizes of the two components.

3. The method as claimed in claim 1, wherein the thickness of respective connection elements is selected from a predetermined grid dimension.

4. The method as claimed in claim 1, wherein the connection-element-specific determination is carried out by a EDP apparatus.

5. The method as claimed in claim 4, wherein the determination is carried out taking into account an assumed loading of the connection elements.

6. The method as claimed in claim 1, wherein for the connection-element-specific determination, data regarding a desired size of the lower and/or upper component, in addition to any deviations from respective desired sizes, are provided.

7. The method as claimed in claim 1, wherein the data of the upper and/or lower component represent or depict at least the height in the connection region, the conicity, the ovality, the surface curvature and/or a weld seam elevation.

8. The method as claimed in claim 1, wherein the connection elements which are used for the structure are colored and/or characterized by an information carrier.

9. The method as claimed in claim 1, wherein at least one connection element is prefabricated and is adapted by the connection-element-specific determination.

10. The method as claimed in claim 1, wherein the connection elements are secured to a lower component and/or an upper component.

11. The method as claimed in claim 10, wherein the surface of one of the components and/or one of the connection elements is coated.

12. The method as claimed in claim 10, wherein the connection elements are arranged on the component whilst it rests on the outer covering face thereof on a roller system.

13. The method as claimed in claim 10, further including a pressing apparatus which presses at least one of the connection elements with a predefined force on the respective component.

14. The method as claimed in claim 1, wherein the data relating to the actual size of the components are obtained by a laser-based measurement apparatus and/or by an image analysis on the basis of images produced by the components.

15. The method as claimed in claim 1, wherein the connection elements are cast in rectangular molds and are subsequently tempered and/or cleaned.

16. A tower-like structure comprising a connection apparatus which is produced as claimed in claim 1.

17. A wind turbine, comprising a tower-like structure as claimed in claim 16.

18. The method as claimed in claim 1, wherein the plurality of connection elements are plate-like.

19. The method as claimed in claim 3, wherein the predetermined grid dimension is in between 10 mm and 120 mm.

20. The method as claimed in claim 5, wherein the determination is carried out taking into account an assumed loading of the connection elements as a result of a load transfer between a lower component and an upper component, wherein respective 2D and/or 3D models are used for the components.

21. The method as claimed in claim 10, wherein at least one of respective surfaces which are brought into connection with each other is/are pretreated, cleaned, surface-activated and/or coated with a bonding agent and/or an adhesive.

22. The method as claimed in claim 11, wherein the surface of one of the components and/or one of the connection elements is coated in a friction-reducing manner with PTFE.
